(19) United States
(12) Patent Application Publication
(10) Pub. No.: US 2011/0059291 A1
(43) Pub. Date: Mar. 10, 2011

(54) STRUCTURED MATERIALS WITH TAILORED ISOTROPIC AND ANISOTROPIC POISSON'S RATIOS INCLUDING NEGATIVE AND ZERO POISSON'S RATIOS

(76) Inventors: Christopher M. Boyce, Winchester, MA (US); Simona Socrate, Winchester, MA (US); Brian P. Greviskes, Boston, MA (US); Mary C. Boyce, Winchester, MA (US)

(21) Appl. No.: 12/876,127

(22) Filed: Sep. 4, 2010

Related U.S. Application Data
(60) Provisional application No. 61/240,248, filed on Sep. 7, 2009.

(51) Int. Cl. B32B 5/18; B32B 3/10; B32B 7/02

(52) U.S. Cl. 428/136; 428/131; 428/218

(57) ABSTRACT

The invention described herein relates to structured porous materials, where the porous structure provides a tailored Poisson's ratio behavior. In particular, the structures of this invention are tailored to provide a range in Poisson's ratio ranging from a negative Poisson's ratio to a zero Poisson's. Two exemplar structures, each consisting of a pattern of elliptical or elliptical-like voids in an elastomeric sheet, are presented. The Poisson's ratios are imparted to the substrate via the mechanics of the deformation of the voids (stretching, opening, and closing) and the mechanics of the material (rotation, translation, bending, and stretching). The geometry of the voids and the remaining substrate are not limited to those presented in the models and experiments of the exemplars, but can vary over a wide range of sizes and shapes. The invention applies to both two-dimensional structured materials as well as three dimensionally structured materials.

### PRIORITY INFORMATION

This application claims priority from provisional application Ser. No. 61/240,248 filed Sep. 6, 2010, which is incorporated herein by reference in its entirety. The invention described herein was partially developed under DARPA contract #W31P4Q-09-C-0473, with 20% of the development funded under this contract, and 80% funded internally.

### BACKGROUND OF THE INVENTION

The invention relates to structured porous materials with tailored isotropic and anisotropic Poisson's ratios, including negative and zero Poisson's ratios, and to methods of fabrication of these structures via “patterning” a “matrix” material with pores or slots or other geometric features. Applications of this invention are directed at the biomedical field (including uses relating to prosthetic materials, surgical implants, and anchors for sutures and tendons, endoscopy, and stents), the mechanical/electrical field (e.g. as piezoelectric sensors and actuators), the protection field (e.g. as armor, cushioning, and impact and blast resistant materials), the filter and sieve field, the fastener field, the sealing and cork fields, and the field of micro-electro-mechanical systems (MEMS).

Auxetic materials are defined as materials with a negative Poisson's ratio, where the Poisson's ratio is the negative of the ratio of a material's lateral strain to its axial strain under uniaxial loading conditions. Most materials have a positive Poisson's ratio i.e. when the material is axially stretched it will laterally contract, whereas when it is compressed it laterally expands. An auxetic material behaves in the opposite manner i.e. when the material is stretched it expands laterally, whereas when it is compressed it contracts laterally. Traditionally, the Poisson's ratio is considered to be a small strain quantity (referring to behavior at strains less than approximately 0.01); the invention of this patent applies to small strains and is also found to be robust to much larger strains (well over 0.10).

Although auxetic materials have been known since at least the 1970s and have gained much attention since 1987 (Lakes, R. S., Science, 1987), their use in engineering applications has been limited. This is primarily due to the nature of the auxetics materials developed/described/discovered thus far, which mainly consist of foams, ceramics, or fibers/fiber networks, often requiring complex methods of manufacturing (Evans and Alderson, 2000). For example, U.S. Pat. No. 4,668,557 proposes a method of fabricating an auxetic foam, whereby a traditional foam is compressed and heated beyond its softening point. As it cools, a permanent deformation of a cellular structure with re-entrant features is locked in, and any subsequent loading results in an auxetic response. Similarly, U.S. Pat. Nos. 6,878,320 and 7,247,265 demonstrate auxetic fibers and a method of producing the fibers whereby heated polymer powder is cohered and extruded via spinning. Here the heating must be monitored very carefully, as the process requires that the surface of the powder pellets melt while the bulk does not. In a third process (U.S. patent application 20050142331) auxetic webs are produced by carefully bonding fibers in a honey-comb-type pattern. Thus, the intricacies of such processes are cost-prohibitive to large scale manufacturing, while the materials themselves are specialized.

In spite of these deficiencies, several applications for auxetic materials have been envisaged and include applications in shock absorbers, air filters, fasteners, aircraft and land vehicles, and electrodes in piezoelectric sensors (Yang, et. al., 2004). To our knowledge, auxetic elastomeric materials and zero Poisson's ratio elastomeric materials have not been reported.

### SUMMARY OF THE INVENTION

There is provided a structured material providing isotropic or anisotropic Poisson's ratios including zero and negative Poisson's ratios. The structured material includes a strain-permitting matrix material and a patterned porous conformation that allows the control of the Poisson's ratio of the structured material. The resulting Poisson's ratio is controlled at small strains (strains less than 1%) and can also be robust to larger strains (strains up to and greater than 10%). The Poisson's ratio behavior of the structured material is a result of the mechanics of deformation of the pores (which can stretch, open, close, rotate, etc.) and the mechanics of deformation of the matrix material (which consists of solid regions which primarily rotate and translate as well as regions which can stretch, bend, or otherwise deform). By varying the placement, size, shape, and orientation of the pores, the structured material's mechanical response to uniaxial tensile and compressive loading can be controlled in the transverse directions. These structured materials can be manifested in both two-dimensional and three-dimensional forms to obtain auxetic structures including, but not limited to, membranes, substrates, sheets, tubes, cylinders, cones, spheres, solid blocks, and other complex shapes. In two dimensional forms, the auxetics behavior enables structured material sheets to conform smoothly to surfaces with single, double, and more complex curvature.

### BRIEF DESCRIPTION OF THE DRAWINGS

FIG. 1 shows one two-dimensional exemplar patterned porous conformation, termed the orthogonal ellipse pattern, or OEP. Here, elliptical pores are arranged perpendicular and offset, such that the major axis of one ellipse runs through the center of the neighboring ellipse, and a small “bridge” of the matrix material runs between each ellipse and its neighbor. This pattern gives rise to a negative Poisson's ratio.

FIG. 2 shows another two-dimensional exemplar patterned porous conformation, termed the staggered ellipse pattern, or SEP. Here, elliptical pores are arranged in side-by-side pairs. Pairs are arranged perpendicular and offset, such that the major axes of one pair is perpendicular to the major axes of neighboring pairs. “Bridges” of the matrix material exist in between the ellipses of an individual pair and between pairs. At the convergence of four neighboring ellipse pairs is a small “island” of the matrix material. This pattern gives rise to a near-zero Poisson's ratio.

FIG. 3 shows one unit of the OEP pulled in tension. As can be seen the elliptical pores open, and the large square regions of matrix material rotate outward.

FIG. 4 shows a structured material patterned with the OEP pulled in uniaxial tension. (1,2) shows a simulation of loading the patterned sheet in tension, while (3,4) show an experiment of loading a ⅛″ thick sheet of EPDM, patterned with a slight variation of the OEP, in tension. The opening elliptical pores and rotating square regions of matrix material give rise to the negative Poisson's ratio effect, and the structured material expands laterally as it is pulled in tension.

FIG. 5 shows one unit of the OEP loaded in uniaxial compression. As can be seen the elliptical pores close and the square regions of matrix material rotate inward.

FIG. 6 shows a structured material patterned with the OEP loaded in compression. The closing elliptical pores and rotating matrix material regions give rise to the negative Poisson's ratio effect, and the structured material contracts laterally as it is compressed.

FIG. 7 shows a sheet patterned with the OEP shown undeformed (left), and shown draped smoothly over a domed surface (right).

FIG. 8 shows two variations of the OEP: the equiaxial OEP, and a biased OEP with elongated elliptical pores in the direction of uniaxial tensile loading (vertical), as well as a plot of the Poisson's ratio as a function of the relative ellipse bias, defined as the ratio of the length of the vertical ellipses to the length of the orthogonal (horizontal) ellipses, demonstrating how the Poisson's ratio of the structured material can be controlled by varying the geometry of the porous conformation.

FIG. 9 shows one unit of the SEP in uniaxial tensile loading. In this case the elliptical pores perpendicular to the direction of loading open up, while the elliptical pores parallel to the direction of loading deform (open at one end and close at the other). The “islands” of matrix material at the convergence of the ellipse pairs rotate, causing the inter-ellipse “bridges” to stretch and rotate. The large square matrix material regions translate in the direction of loading. These mechanisms work together to give a nearly zero Poisson's ratio for the structured material i.e. no lateral expansion or contraction.

FIG. 10 (1,2) shows a structured material patterned with the SEP in uniaxial tensile loading. (3,4) shows a ⅛″ thick sheet of EPDM, patterned with a slight variation of the SEP, in uniaxial tension. The structured material neither expands nor contracts laterally.

FIG. 11 shows a structured material patterned with the SEP loaded in uniaxial compression. The structured material neither expands nor contracts laterally.

FIG. 12 shows two variations of the SEP with different values of the relative stagger distance, defined as the ratio of the distance between parallel ellipses relative to the distance between parallel ellipses in the OEP. FIG. 12 also contains a plot of the Poisson's ratio as a function of the relative stagger distance, demonstrating how the Poisson's ratio of the structured material can be controlled by varying the geometry of the porous conformation.

FIG. 13 shows a three-dimensional exemplar patterned porous conformation, termed the 3D orthogonal disk pattern, or 3DODP. Here, rounded disk-shaped pores are arranged perpendicular (along 3 directions) and offset, such that the major axis of one disk runs through the center of the neighboring disk, and a small “bridge” of the matrix material runs between each disk and its neighbor. This pattern gives rise to a negative Poisson's ratio along both directions orthogonal to the direction of loading.

FIG. 14 shows another three-dimensional exemplar patterned porous conformation, obtained by taking an axisymmetric sweep of the OEP. A wedge of the structured material is removed for clarity. This pattern gives rise to a negative Poisson's ratio along both directions (radial and circumferential) orthogonal to the (axial) direction of loading.

FIG. 15 shows another three-dimensional exemplar patterned porous conformation, obtained by wrapping a two-dimensional OEP patterned sheet along the surface of a round cylinder. One quarter of the cylinder is shown. As the cylinder is elongated along its axis, its radius increases. This porous conformation provides the means to control the transverse expansion and contraction of the cylinder by imposing an axial deformation, stretching or shortening the cylinder's length.

### DETAILED DESCRIPTION OF THE INVENTION

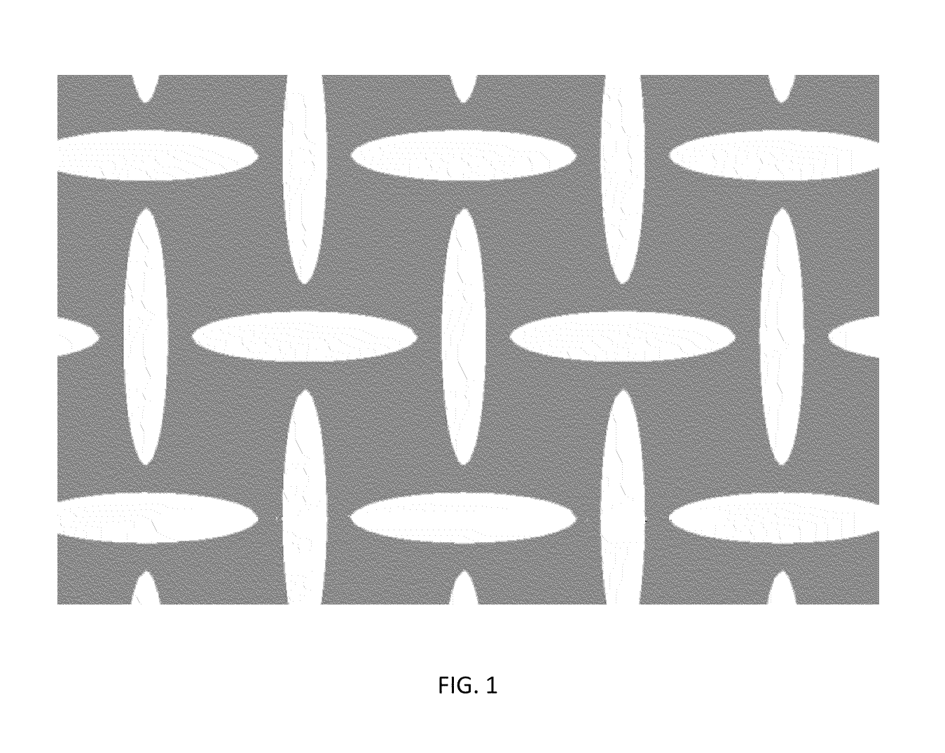

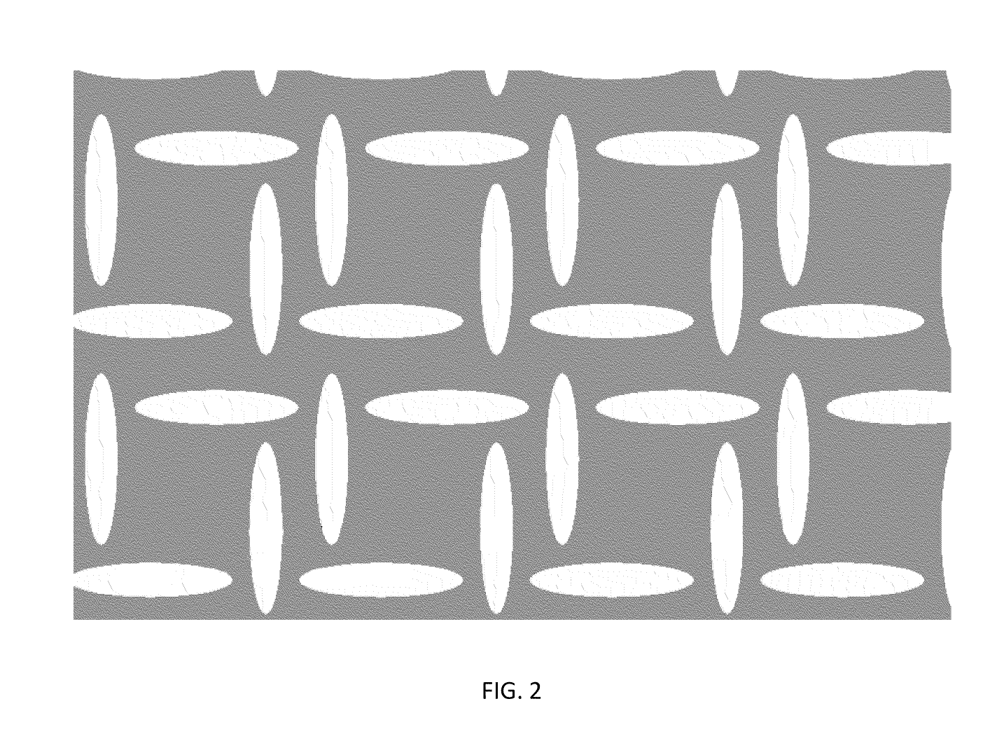

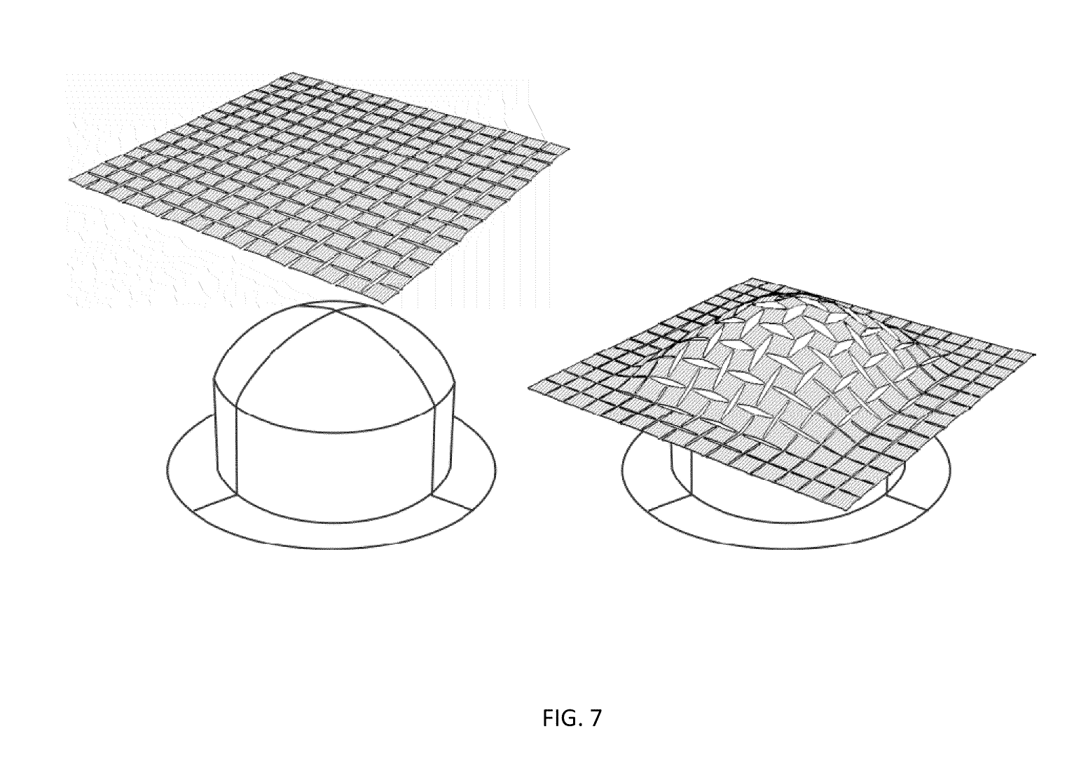

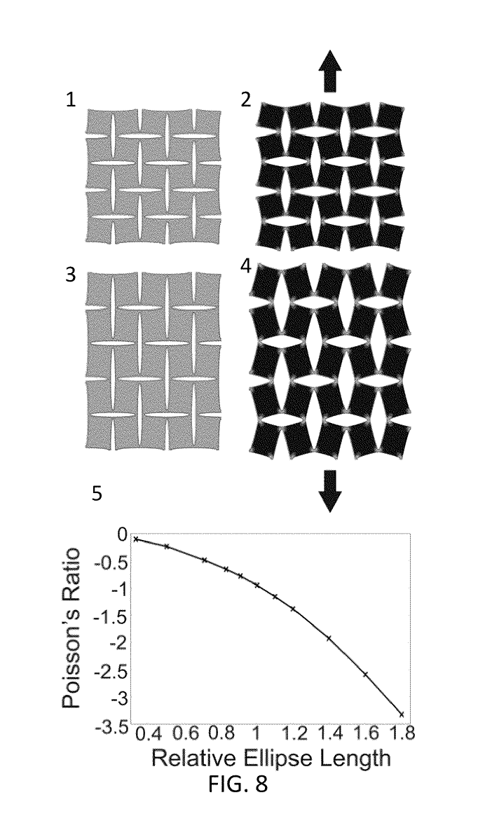

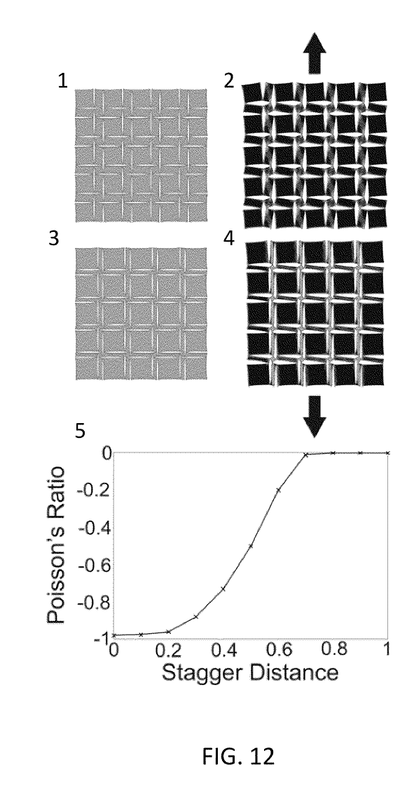

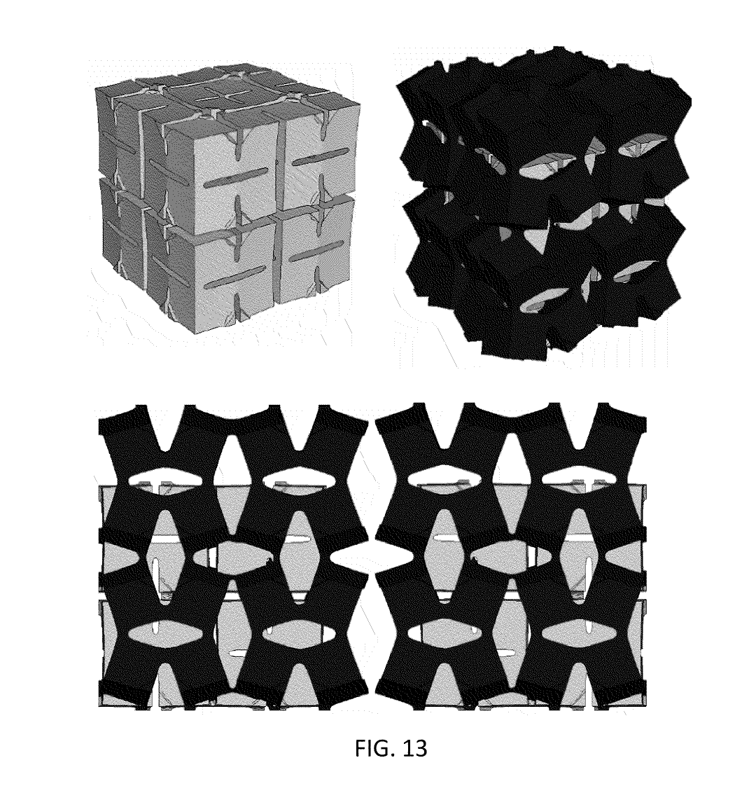

The invention provides a structured material, providing isotropic or anisotropic Poisson's ratios including zero or even a negative Poisson's ratio. The structured material includes a strain-permitting matrix material and a patterned porous conformation that allows the control of the Poisson's ratio of the structured material. The resulting Poisson's ratio is controlled at small strain (strains less than 1%) and may also be robust to larger strain (strains up to and greater than 10%). The material is patterned with a repeating pattern of voids, which can be cut, molded, printed, or otherwise imparted into the material (2-D sheets or 3-D solids). The material can be polymeric (including, but not limited to, unfilled or filled vulcanized rubber, natural or synthetic rubber, crosslinked elastomer, thermoplastic vulcanizate, thermoplastic elastomer, block copolymer, segmented copolymer, crosslinked polymer, thermoplastic polymer, filled or unfilled polymer, or epoxy) but may also be non-polymeric (including, but not limited to, metallic and ceramic and composite materials). Several exemplar patterned structures are used to illustrate the invention: the exemplar structures in FIGS. 1 through 12 consist of two-dimensional patterns of ellipsoidal pores in elastomeric sheets. In the exemplar application, the sheets are loaded uniaxially, and the in-plane strain transverse to the loading direction is controlled by the patterned porous conformation. The first pattern in FIG. 1 (OEP and variations of this pattern) results in lateral expansion when the patterned sheet is pulled in uniaxial tension, or lateral contraction when the patterned sheet is shortened in uniaxial compression. Variations in the bias of the pore patterning, shown in FIG. 8, allow the control of the in-plane Poisson's ratio in a range from 0 to large negative values. An example is shown in FIG. 7, demonstrating that this phenomenon enables a sheet, patterned with the OEP pattern, to conform smoothly to double curvature surfaces, highlighting the ability to tailor these patterns to allow conformability to double and more complex curvature surfaces. A second exemplar two-dimensional pattern is shown in FIG. 2 (SEP and variations of this pattern). Variations in the pitch of the pore patterning, shown in FIG. 12, allow the control of the in-plane Poisson's ratios in a range from 0 to −1. Exemplar patterned structures that illustrate the invention in its full three-dimensional embodiment are shown in FIGS. 13, 14, and 15. The patterned structures in FIGS. 13 through 15 demonstrate the application of the invention to create patterned materials with negative Poisson's ratio three-dimensionally (i.e. in both lateral directions). Similarly to the two dimensional applications, the Poisson's ratios in the two transverse directions can be controlled by varying the bias in the pore dimensions, or by staggering the pores with variable pitch.

The nature of this invention avoids limitations that have hampered the development of auxetics to-date, as a wide variety of materials, polymeric and non-polymeric, can be used. The fabrication of the 2-D structures is straightforward, and can be achieved by a number of manufacturing approaches e.g. via water jet cutting, laser cutting, die cutting, stamping, injection molding, compression molding, vulcanization, or a combination of these or other processes, depending on the particular material. Similarly, the fabrication of 3-D structures is straightforward, and can be achieved by a number of processes including 3D printing and sintering. Finally, manufacturing processes such as microfabrication techniques and interference lithography enable the fabrication of such porous structures at the lengthscale of micrometers.

The two illustrative patterns shown in FIGS. 1 and 2 consist of repeating units of ellipsoidal pores, surrounding large square-like or rectangular-like domains of matrix material. Note that in other embodiments of this invention repeating pores, slits, slots, notches, cuts, or other geometric shapes can surround matrix material domains of different shapes (triangular, circular, oblong, irregular, etc.).

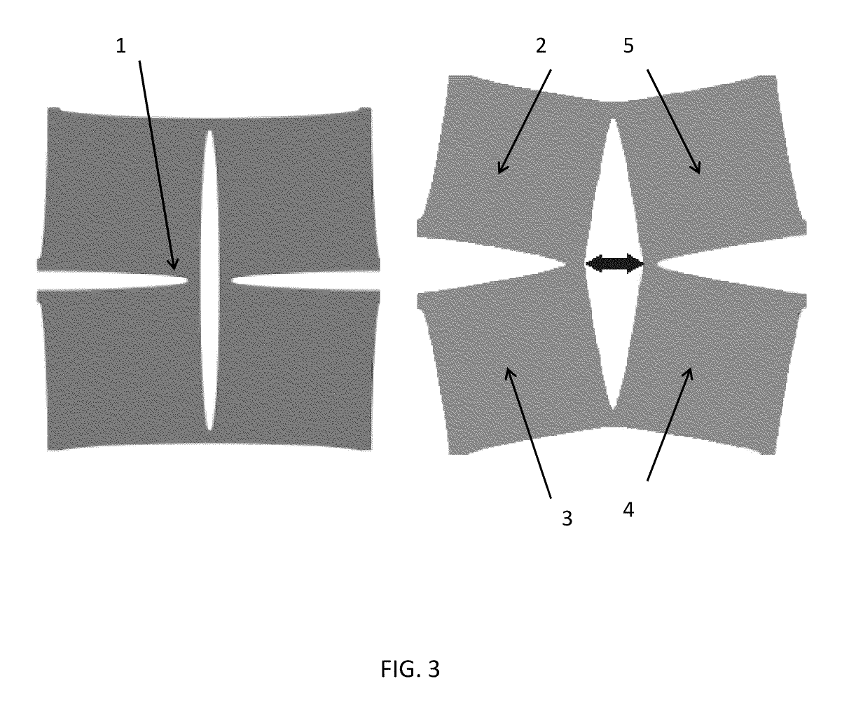

FIG. 1 shows the orthogonal ellipse pattern or OEP. Here, the ellipsoidal pores are offset such that the major axis of an ellipse runs through the center of the neighboring ellipse and a small “bridge” of polymer runs between each ellipse and its neighbor. This “bridge” is highlighted in FIG. 3 (1). During macroscopic tension, this “bridge” acts as a hinge, opening the ellipsoidal pores and rotating the remaining matrix regions, shown in FIG. 3 (2-5), outward. During macroscopic compression the “bridge” acts as a hinge in the opposite direction, closing the ellipsoidal pores and rotating the remaining matrix regions inward.

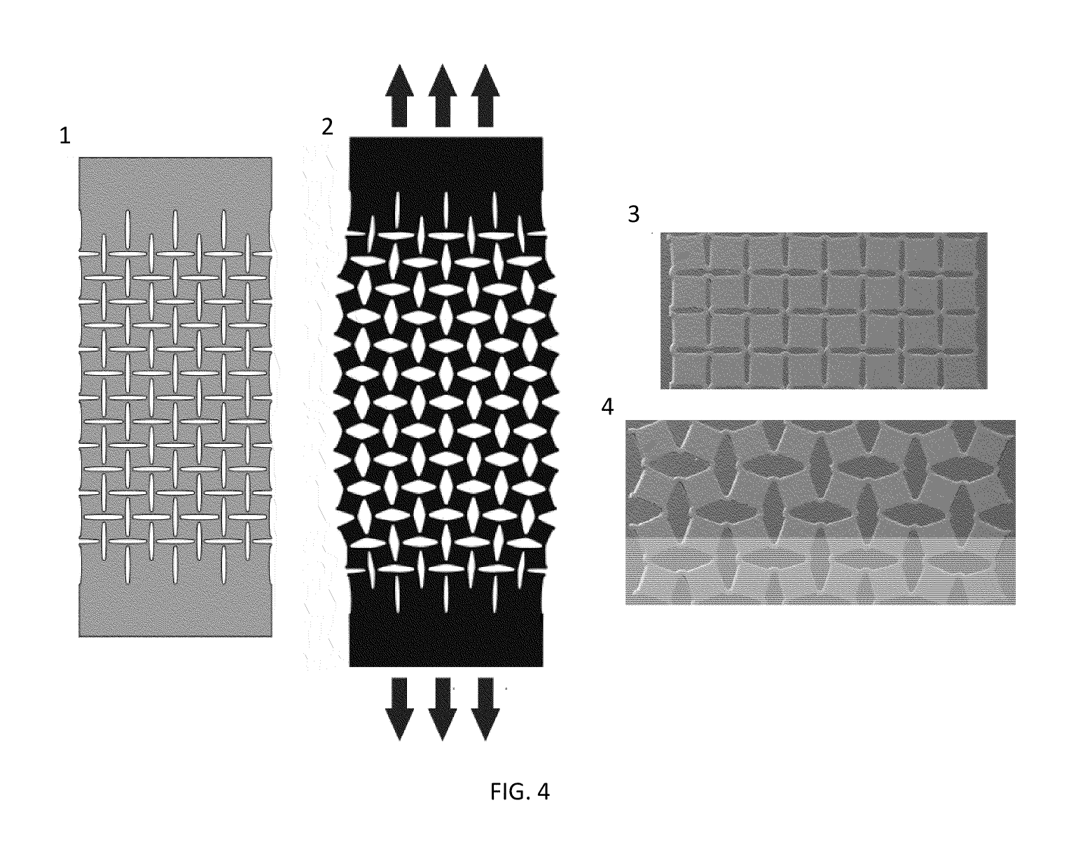

FIG. 3 further highlights this hinge mechanism in tension. As can be seen, the pores open, and the square matrix regions rotate outwards i.e. two of the square matrix regions (2,4) rotate clockwise, while the other two square matrix regions (3,5) rotate counterclockwise. This causes the sheet to expand laterally. FIG. 4 (1,2) shows simulations of the sheet in the undeformed state and at a macroscopic tensile strain of 0.10, as well as experiments (3,4) of a ⅛″ thick sheet of EPDM, patterned with a variation of the OEP, undeformed and at a macroscopic tensile strain of 0.10. The simulation and experiment highlight the magnitude of the lateral expansion. The macroscopic Poisson's ratio for this pattern was measured to be approximately equal to −1.

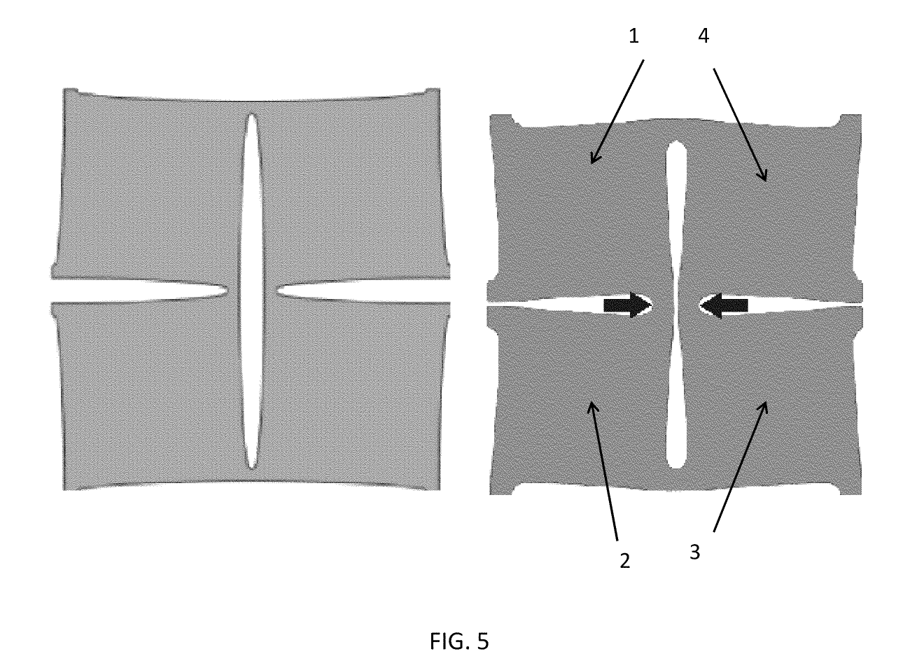

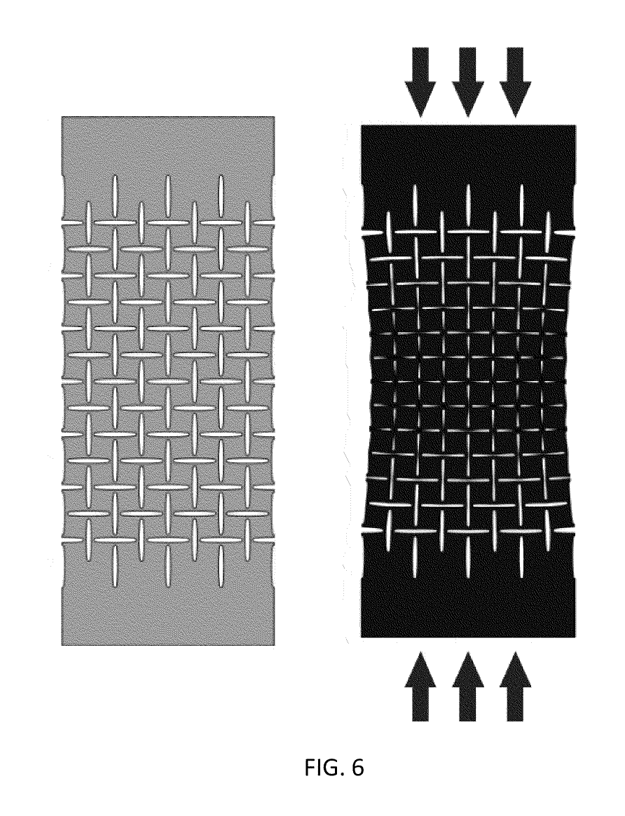

FIG. 5 highlights this hinge mechanism in compression. Here the pores close and the square matrix regions (1-4) rotate inwards, with matrix regions (2,4) rotating clockwise, and matrix regions (1,3) rotating counterclockwise. This causes the sheet to contract laterally. FIG. 6 shows the sheet in the undeformed state and at a macroscopic compressive strain of 0.05, highlighting the magnitude of the lateral contraction.

An interesting result of the Poisson's ratio behavior of this pattern is that it can be used to construct 2D structures, which can deform differently in different regions. For example, a sheet patterned with this pattern can expand in the center, while contracting around the edges. This allows the sheet to conform smoothly to double and more complex curvatures surfaces, e.g. a dome. This phenomenon is shown in FIG. 7. This phenomenon is predictable, and similar patterns can be constructed, which allow for 2D structures that can conform smoothly to any arbitrary surface curvature.

Finally, the magnitude of the Poisson's ratio of the OEP can be tailored by varying the aspect ratios of the ellipsoidal pores. FIG. 8 shows the traditional OEP undeformed (1) and deformed to 10% macroscopic tensile strain (2), and a variation of the OEP, made by increasing the length of the pore's major axis in the direction parallel to loading, again shown undeformed (3), and deformed to 10% macroscopic tensile strain (4). Here, the major axis of vertical ellipsoidal pores is 50% longer than the major axis of the horizontal ellipsoidal pores. As can be seen this pattern demonstrates a much larger negative Poisson's ratio. The plot in FIG. 8 (5) shows the value of Poisson's ratio for different relative ellipse length, where 0.5 corresponds to the major axis of vertical ellipses being 50% as long as the major axis of horizontal ellipses, and 1.5 corresponds to the major axis of vertical ellipses being 50% longer than the major axis of horizontal ellipses.

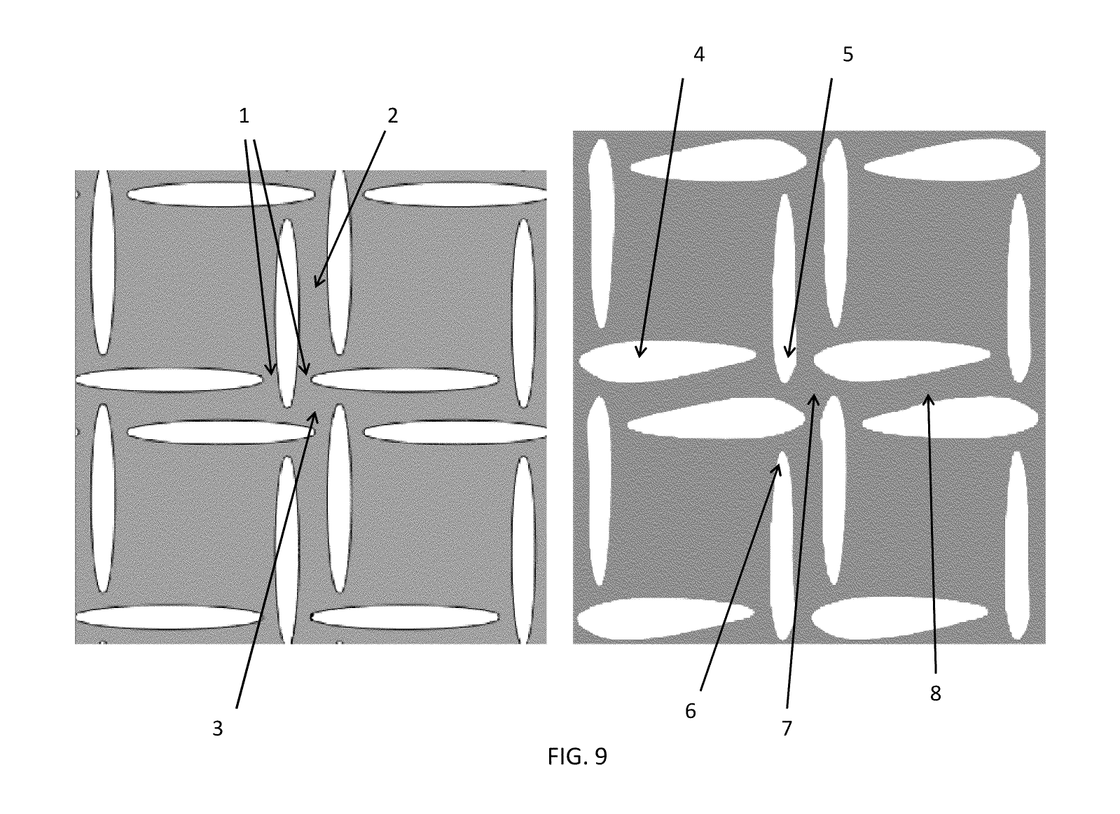

In the staggered ellipse pattern or SEP pattern shown in FIG. 2 the ellipsoidal pores are offset with alternating sets of side-by-side pores. The two pores of each side-by-side pair are offset such that the center of each pore is spaced some distance (the magnitude of the offset can be varied) in both the horizontal and vertical direction from its mate. Two more sets of side-by-side pores run perpendicular to the first set, with one set at each tip of the first set. FIG. 9 further highlights this geometry, where small “bridges” (1) exist between each pore and its nearest neighbor set. However, in this case, there are also “bridges” (2) between the two members of each side-by-side set. At the convergence of four sets, a small square “island” (3) of matrix material exists.

During tensile loading, the pores open and deform. The pores that are oriented perpendicular to the direction of stretching open, as seen in FIG. 9 (4), while the pores parallel to the direction of stretching deform (the end bordering on the “island” region opens slightly (5), while the other end closes slightly (6)). The “island” itself rotates (7), allowing the “bridges” between the two members of each side-by-side pair to rotate (8), which compensates for the behavior stated previously (one end of the pore opening while the other closes). A similar response is seen in compressive loading, though in this case the pores perpendicular to the direction of loading close instead of opening. In both cases, the remaining matrix regions translate in the direction of loading. This mechanism is highlighted in FIG. 9.

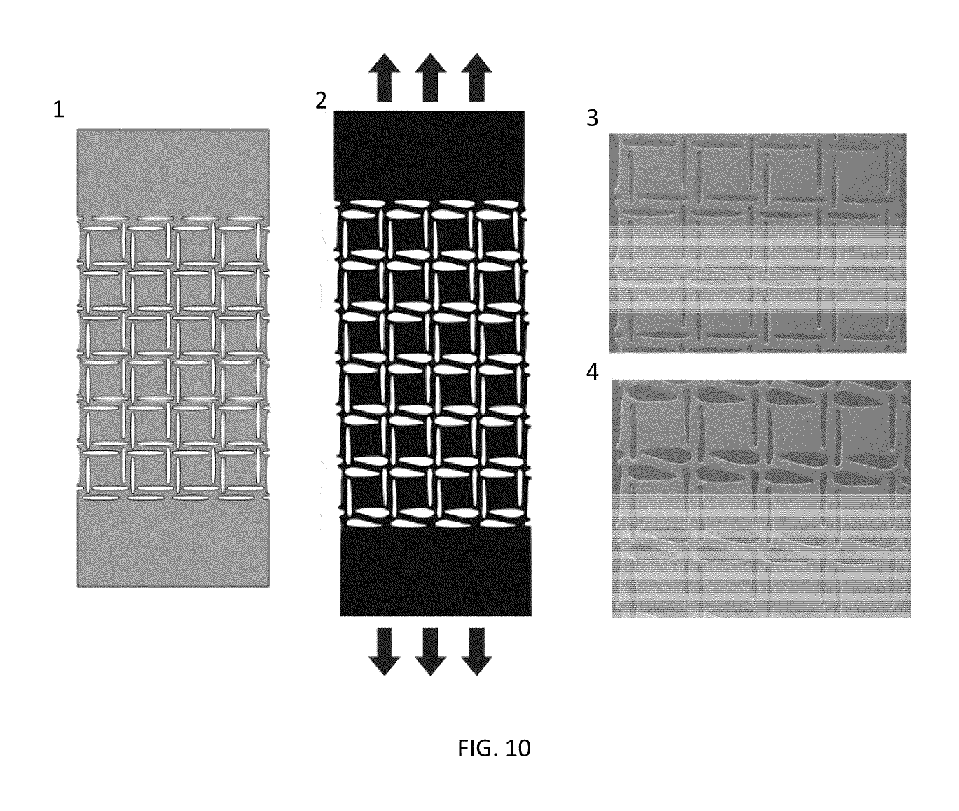

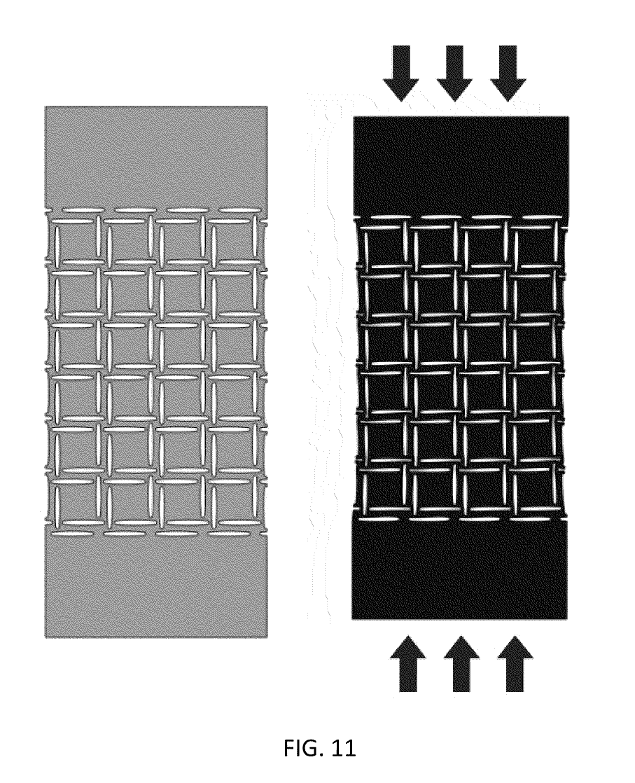

Because the pores parallel to the direction of stretching do not significantly contract or expand laterally, and because the remaining matrix regions do not strain significantly, the overall pattern neither expands nor contracts laterally during deformation, giving an overall Poisson's ratio of near zero. FIGS. 10 and 11 show simulations and experiments of a sheet with the SEP loaded in tension and compression respectively.

As in the OEP, the magnitude of the Poisson's ratio of the SEP can be tailored by altering the pattern. Here, the magnitude of the “stagger distance”, defined as the distance between parallel elliptical pores, relative to the distance between parallel elliptical pores in the OEP, is varied, where a “stagger distance” of 0 corresponds to the OEP pattern, and a “stagger distance” of 1 corresponds to the parallel ellipses almost touching. FIG. 12 shows two stagger distances: 0.4 (1 and 2), and 0.7 (3 and 4). As can be seen, the magnitude of the negative Poisson's ratio is greater in the first case (1 and 2), as noted by the increased (relative to 3 and 4) lateral expansion for the same macroscopic deformation. FIG. 12 (5) plots the Poisson's ratio vs. the stagger distance, demonstrating that for this pattern, the Poisson's ratio can range in value from −1 to 0.

Because the remaining matrix regions, which account for a large percentage of the sheet surface, undergo very limited in-plane strain, they exhibit very small transverse strain in the direction normal to the plane of the sheet, so that these patterned sheets exhibit near-zero macroscopic Poisson ratio in the out-of-plane direction. Therefore the OEP exhibits an anisotropic response, with a negative in-plane Poisson's ratio, and a zero out-of-plane Poisson's ratio, while the SEP exhibits a near zero Poisson's ratio in both directions.

The conceptual approach followed to obtain the two-dimensional (2D) auxetic structures can be extended to obtain three-dimensional (3D) auxetic structures, with tailored Poisson's ratio in both transverse directions. FIG. 13 illustrates the 3D analog of the first exemplar pattern, termed the 3-D orthogonal disk pattern, or 3DODP, where the three-dimensional patterned porous conformation consists of rounded disk-shaped pores, arranged perpendicular (along 3 directions) and offset, such that the major axis of one disk runs through the center of the neighboring disk, and a small “bridge” of the matrix material runs between each disk and its neighbor. The pores define cuboidal domains which rotate when the structure is loaded uniaxially, resulting in equal lateral expansion in both transverse directions. The 3DODP is co-continuous (meaning that the void and the solid regions are both continuous) and can be fabricated by a variety of processes, including, 3D printing, lithography, and high speed sintering.

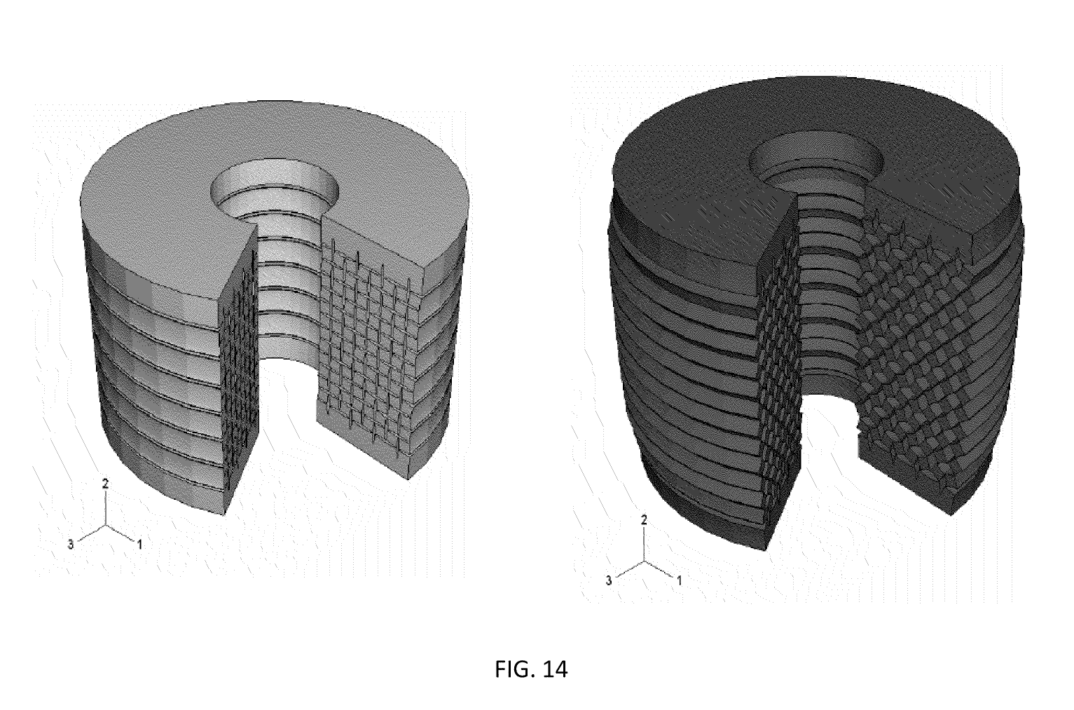

As an alternative approach to obtain 3D structures with biaxial tailored Poisson's ratios, the 2D porous conformations can be cut through cylindrical or prismatic structures. An example of this approach is illustrated in FIG. 14, where an axisymmetric sweep of the OEP has been used to construct an auxetic cylinder. When the cylinder is extended in the axial direction, the wall of the cylinder thickens, so that the cylinder expands equally in all transverse directions (a wedge of the cylinder has been cut in the picture to illustrate the transverse deformation). This manifestation of the invention is particularly relevant to sealing and cork type applications.

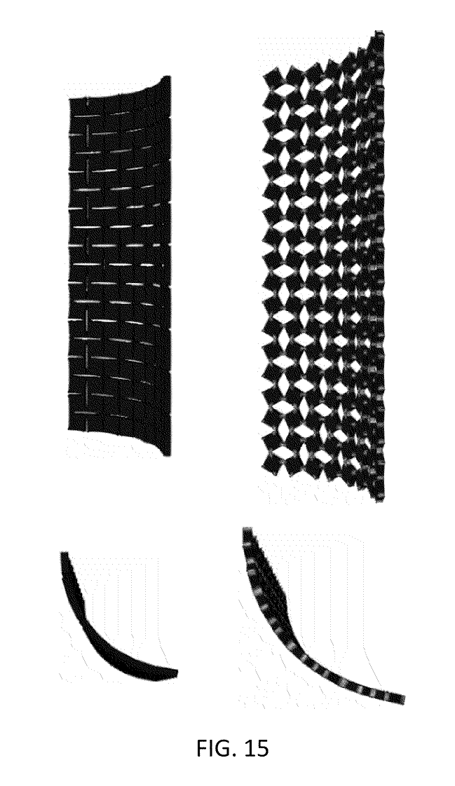

Finally, in a third approach to obtaining 3D auxetic structures, a 2D patterned sheet can be wrapped around a cylinder. In this way, the negative Poisson's ratio of the sheet causes a transverse expansion, when loaded in macroscopic tension, or a transverse contraction, when loaded in macroscopic compression, leading to an expansion or constriction of the cylinder. This phenomenon is shown in FIG. 15. This manifestation of the invention is particularly relevant to surgical implants and stents, where a macroscopic stretching or shortening of the cylinder, easily controlled by coaxial cables and wires, can be used to increase and decrease the lumen of the stent. Although the present invention has been shown and described with respect to several preferred embodiments thereof, various changes, omissions and additions to the form and detail thereof, may be made therein, without departing from the spirit and scope of the invention.

### REFERENCES

### US Patents

1) U.S. Pat. No. 4,668,557 Lakes, 1987

2) U.S. Pat. No. 6,878,320 Alderson et al., 2005

3) U.S. Pat. No. 7,247,265 Alderson et al., 2007

4) US20050142331 Anderson et al., 2005

5) U.S. Utility application Ser. No. 12/822,609 Boyce et al., 2010 (Filing date: Jun. 24, 2010)

6) U.S. Provisional Patent Application 61,240,248 Boyce, et al., 2009 Other Referenced Publications

7) Bertoldi, K., Boyce, M. C.; Deschanel, S., Prange, S. M., Mullin, T., “Mechanics of deformation-triggered pattern transformations and superelastic behavior in periodic structures.” Journal of the Mechanics and Physics of Solids. 56:8:2642-2668, 2008a.

8) Bertoldi, K., Boyce, M. C., “Mechanically Triggered Phononic Band Gaps in Periodic Elastomeric Structures”, Physical Review B, 052105, 2008b.

9) Evans, K. E., Alderson, A. “Auxetic Materials: Functional Materials and Structures from Lateral Thinking.” Advanced Materials. 12:9: 617-628, 2000

10) Evans, K. E., Caddock, B. D. “Microporous materials with negative Poisson's ratios: II. Mechanisms and interpretation.” J. Phys. D: Appl. Phys. 22:1883-1887, 1989.

11) Evans, K. E. “Tensile network microstructures exhibiting negative Poisson's ratios.” J. Phys. D: Appl. Phys. 22: 1870-1876, 1989.

12) Lakes, R. S.; “Foam structures with a negative Poisson's ratio.” Science. 235:4792:1038-1040. 1987.

13) Peel, L. D., “Exploration of high and negative Poisson's ratio elastomer-matrix laminates.” Physica Status Solidi B-Basic Solid State Physics. 244:3:988-1003, 2007.

14) Yang, W., Li, Z. M., Shi, W., Xie, B. H., Yang, M. B. “On Auxetic Materials.” Journal of Materials Science. 39:3269-3279, 2004.

1. A structured porous material consisting of a matrix material patterned with voids or pores, whereby the void pattern is tailored to obtain a prescribed transverse response with a negative or zero or positive Poisson's ratio, which is robust at small (less than 1%) strain and may also be robust to large strain (up to and greater than 10%).

2. The structured porous material of claim 1 made by patterning the material with a pattern of voids, whereby the negative and/or zero Poisson's ratio behavior is a result of the mechanics of the deformation of the voids and the mechanics of the deformation of the remaining material.

3. The structured porous material of claim 1 whereby the voids are instead regions composed of a second material with a high compressibility (low bulk modulus).

4. A structured porous material of claim 1 whereby the voids are elliptical, ellipsoidal, or disk-like voids, slits, cuts, slots or other geometric shapes arranged such that the pattern imparts a negative Poisson's ratio to the material.

5. The porous material of claim 1, whereby the constituent material consists of polymer such as an unfilled or filled vulcanized rubber, natural or synthetic rubber, crosslinked elastomer, thermoplastic vulcanizate, thermoplastic elastomer, block copolymer, segmented copolymer, crosslinked polymer thermoplastic polymer, filled or unfilled polymer or epoxy.

6. The porous material of claim 1, whereby the constituent material is non-polymeric.

7. The porous material of claim 1, whereby the void pattern is irregular, and/or the voids take on any variation in shape, size, distribution, and orientation, including graded patterns.

8. The porous material of claim 1, whereby the remaining material (separate from the voids) may take on any variation in shape, size, or orientation, including graded patterns and tapering thickness when used in sheet form.

9. The porous material of claim 1, whereby the patterned structure enables conformation to curved surfaces and housings including single curvature cylinders, graded curvatures such as cones, double curvatures (such as spheres), and irregular curvatures.

10. The utilization of the patterns of any of the claims 1 through 9) to fabricate sensors, actuators, prosthetics, surgical implants, anchors, (as for sutures, tendons, ligaments, or muscle), fasteners, seals, corks, filters, sieves, shock absorbers, impact-mitigating materials, hybrids, or structures, impact absorption or cushioning materials, hybrids, or structures, wave propagation control materials, hybrids, or structures, blast-resistant materials, hybrids, or structures, MEMS components, and/or stents.
